(19) United States
(12) Patent Application Publication
(10) Pub. No.: US 2021/0283761 A1
(43) Pub. Date: Sep. 16, 2021

(54) Method for Enabling an Active Operating State of a Hand-Held Power Tool According to Whether an Item of Protective Equipment is Carried or Worn by an Operator of the Hand-Held Power Tool

(71) Applicant: Robert Bosch GmbH, Stuttgart (DE)

(72) Inventors: Joachim Schadow, Stuttgart (DE); Florian Esenwein, Leinfelden-Echterdingen (DE); Benjamin Brechter, Leinfelden-Echterdingen (DE)

(21) Appl. No.: 16/334,462

(22) PCT Filed: Sep. 11, 2017
(86) PCT No.: PCT/EP2017/072677

§ 371 Date: Mar. 19, 2019

(30) Foreign Application Priority Data
Sep. 19, 2016 (DE) 10 2016 217 835.0

(51) Int. Cl. B25F 5/00; A41D 13/00; A41D 1/00

(52) U.S. Cl. CPC B25F 5/00; A41D 1/002; A41D 13/0002

(57) ABSTRACT

A method enables at least one active operating state of a hand-held power tool with at least one mobile functional unit according to whether an item of protective equipment is carried and/or worn by an operator of the hand-held power tool. The mobile functional unit is integrated on or in the hand-held power tool and is configured to control the active operating state of the hand-held power tool. The method includes sending at least one first ID of a first protective equipment element of a first item of protective equipment to the mobile functional unit, and the mobile functional unit receives the first ID of the first protective equipment element of the item of protective equipment. The method also includes enabling the active operating state of the hand-held power tool with the mobile functional unit by switching on at least one electric power supply for the hand-held power tool.

The invention relates to a method for enabling an active operating state of a hand-held power tool in dependence on whether an item of protective equipment is carried or worn by an operator of the hand-held power tool.

### PRIOR ART

### Disclosure of the Invention

In the method according to the invention as claimed in claim 1, enabling of at least one operating state of a hand-held power tool is effected by at least one mobile functional unit in dependence on whether an item of protective equipment is carried and/or worn by an operator of the hand-held power tool. An active operating state of the hand-held power tool is to be understood here to mean, in particular, a state in which an electromotive drive of the hand-held power tool performs work. In this state, an electrical energy drives the electromotive drive unit, in particular an electric motor.

The hand-held power tool may be a drill/driver, a power drill, a power percussion drill, a screwdriver, an impact wrench, a hammer drill, a chipping hammer, a grinder, a planer, a router, a multicutter, a sawing tool, or the like.

A mobile functional unit is to be understood here to mean, in particular, a device designed for monitoring, controlling, recording information, outputting information, or the like.

Advantageously, there is a mobile functional unit integrated on or in the hand-held power tool. The mobile functional unit advantageously controls the active operating state of the hand-held power tool. That has the advantage that the hand-held power tool is switched on only if the item of protective equipment is worn by an operator.

Advantageously, in a first method step, at least one ID of at least one first protective equipment element of a first item of protective equipment is sent to at least the mobile functional unit. The hand-held power tool thus only receives the signal when the item of protective equipment is worn.

Enabling of at least one active operating state of the hand-held power tool is advantageously effected, in dependence on whether the item of protective equipment is carried or worn by the operator of the hand-held power tool, in that a signal is sent from the mobile functional unit to the mobile functional unit and an electrical energy supply for the hand-held power tool is activated by the mobile functional unit. The hand-held power tool is thus only switched on when the item of protective equipment is carried. This increases the safety of an operator of a hand-held power tool.

In one embodiment, the functional unit is arranged at the interface to a rechargeable battery of the hand-held power tool.

In a further embodiment, the functional unit is arranged at the interface to a mains electrical power connection of the hand-held power tool.

In a further embodiment, the functional unit is arranged in the hand-held power tool.

Further advantages and expedient embodiments are given by the description of the figures and the drawings.

### DRAWINGS

The drawings show exemplary embodiments of the method according to the invention for enabling an active operating state of a hand-held power tool in dependence on whether an item of protective equipment is carried or worn by an operator of the hand-held power tool.

There are shown:

FIG. 1 a system for executing the method,

FIG. 2 a flow diagram of a first method for enabling an active operating state of a hand-held power tool in dependence on whether an item of protective equipment is carried or worn by an operator of the hand-held power tool,

FIG. 3 a flow diagram of a second method for enabling an active operating state of a hand-held power tool in dependence on whether an item of protective equipment is carried or worn by an operator of the hand-held power tool,

FIG. 4 a flow diagram of a third method for enabling an active operating state of a hand-held power tool in dependence on whether an item of protective equipment is carried or worn by an operator of the hand-held power tool.

### DESCRIPTION

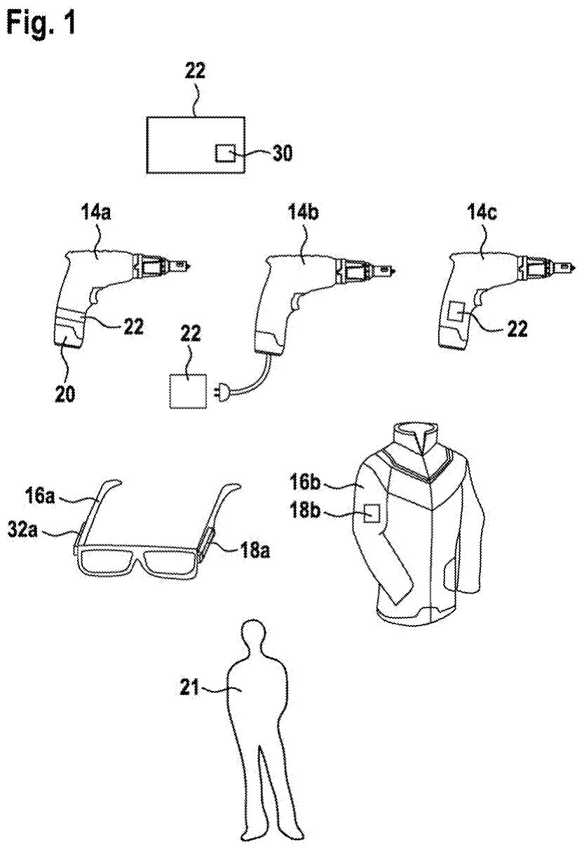

FIG. 1 shows a system comprising at least one mobile functional unit 22, at least one hand-held power tool 14a and at least one item of protective equipment 16a, the item of protective equipment 16a having at least one protective equipment element 18b. In the exemplary embodiment the item of protective equipment 16a is realized as safety eyewear. It is also conceivable, however, for the item of protective equipment 16a to be realized as a jacket, as trousers, as a helmet, as work shoes, as a waistcoat, as a glove or the like. In the embodiment according to the invention, the protective equipment element 18b has a sending unit for sending an ID, and has an energy storage unit. In the embodiment, the hand-held power tool 14a is a battery-operated hand-held power tool 14a having a rechargeable battery 20. The mobile functional unit 22 is arranged between the rechargeable battery 20 and the hand-held power tool 14a, at an interface of the hand-held power tool 14a to the rechargeable battery 20.

An operator 21 wears the item of protective equipment 16a and carries the hand-held power tool 14a.

Furthermore, the system may include the following components, the list being non-exhaustive:
a second hand-held power tool 14ab
a second item of protective equipment 16b, comprising a second protective equipment element 18b
a multiplicity of hand-held power tools
a multiplicity of items of protective equipment, comprising a multiplicity of protective equipment elements

The item of protective equipment 16b is realized as a jacket. It is also conceivable, however, for the item of protective equipment 16a to be realized as protective work eyewear, as trousers, as a helmet, as work shoes, as a waistcoat, as a glove or the like. In the embodiment according to the invention, the protective equipment element 18b has a sending unit for sending an ID, and has an energy storage unit. The hand-held power tool 14b is a mains-operated hand-held power tool 14b having a mains-power cable 24. A mobile functional unit 22 is arranged at the interface of the mains-power cable 24 of the hand-held power tool 14b to the mains energy supply system.

In a third embodiment, the mobile functional unit 22 is integrated in the hand-held power tool 14c (FIG. 1).

The method according to the invention for the enabling of at least one active operating state of a hand-held power tool 14a, 14b, 14c by at least one mobile functional unit in dependence on whether an item of protective equipment 16a is carried and/or worn by an operator of the hand-held power tool can proceed in differing variants, and is described in the following exemplary embodiments.

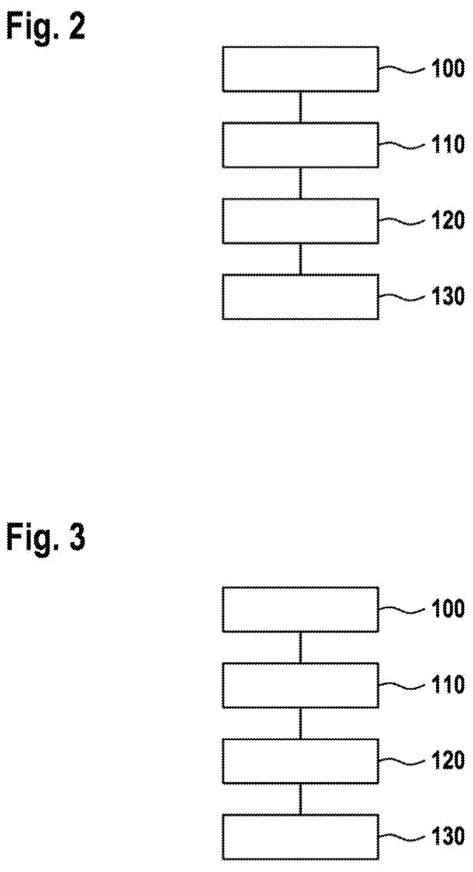

FIG. 2 shows that, in a first method step 100, the ID of the first protective equipment element 18a of the first item of protective equipment 16a is sent to the mobile functional unit 22. The mobile functional unit 22 receives the ID of the first protective equipment element 18a of the first item of protective equipment 16a. In a second method step 110, the mobile functional unit 22 enables an active operating state of the hand-held power tool 14a, 14b, 14c, in that an electrical power supply for the hand-held power tool 14a, 14b, 14c is activated.

In a further method step 120, the mobile functional unit receives the ID of the second protective equipment element 18b of the item of protective equipment 16b.

In a further method step 130, the mobile functional unit 22, upon receiving the first ID of the first protective equipment element 18a of the first item of protective equipment 16a and the second ID of the second protective equipment element 18b of the second item of protective equipment 16b, enables an active operating state of the hand-held power tool 14a, 14b, 14c, in that an electrical energy supply for the hand-held power tool 14a, 14b, 14c is activated.

The mobile functional unit 22 is equipped with a data storage unit 30. The data storage unit 30 is designed to store a list of all IDs of the protective equipment elements 18a, 18b of the items of protective equipment 16a, 16b.

The method in FIG. 3 shows that, in a first method step 100, a first operator-specific characteristic quantity is sensed by at least one first sensor unit 32a of the first item of protective equipment 16a. An operator-specific characteristic quantity is to be understood to mean a temperature, a moisture, an acceleration and/or a field strength. If a user 21 is wearing the eyewear, the user-specific characteristic quantity indicates, for example, a temperature, a moisture and/or capacitance of the skin of the operator, and therefore whether the eyewear is being worn correctly. The sensor unit 32 is realized as a temperature sensor, a moisture sensor, an acceleration sensor, a capacitive sensor or as a magnetic field sensor.

In a further method step 110, the first operator-specific characteristic quantity is converted into a sensor signal. In a further method step 120, the sensor signal is transmitted to the mobile functional unit 22. In the method step 130, enabling of an active operating state of the hand-held power tool 14a, 14b, 14c is effected by the mobile functional unit 22 in that an electrical energy supply for the hand-held power tool 14a, 14b, 14c is activated.

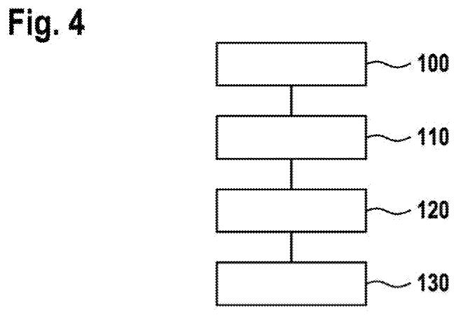

The method in FIG. 4 shows that, in a first method step 100, a first ID of a first protective equipment element 18a of a first item of protective equipment 16a is sent to a mobile functional unit 22. The mobile functional unit 22 receives the first ID of the first protective equipment element 18a of the first item of protective equipment 16a. In a second method step 110, a first operator-specific characteristic quantity is sensed by a first sensor unit 32a. In a third method step 120, from the first operator-specific characteristic quantity is converted into a sensor signal. In a further method step 130, the mobile functional unit 22 enables an active operating state of the hand-held power tool 14a, 14b, 14c, in that an electrical energy supply for the hand-held power tool 14a, 14b, 14c is activated.

An operator-specific characteristic quantity is to be understood to mean a temperature, a moisture, an acceleration and/or a capacitance. If a user 21 is wearing the eyewear, the user-specific characteristic quantity indicates, for example, a temperature, a moisture and/or capacitance of the skin of the operator, and therefore whether the eyewear is being worn correctly. The sensor unit 32 is realized as a temperature sensor, a moisture sensor, an acceleration sensor, a capacitive sensor or as a magnetic field sensor.

A list of all IDs of the protective equipment elements 18a, 18b of the items of protective equipment 16a, 16b are stored in a data storage unit 30 of the mobile functional unit 22.

It is also conceivable, however, that, in a further method, a mobile functional unit 22 receives the IDs of a plurality of protective equipment elements of a plurality of items of protective equipment, and enables an active operating state of the hand-held power tool 14a, 14b, 14c, in dependence on whether the item of protective equipment is worn, in that an electrical energy supply for the hand-held power tool 14a, 14b, 14c is activated.

1. A method for enabling at least one active operating state of a hand-held power tool by at least one mobile functional unit in dependence on whether an item of protective equipment is carried and/or worn by an operator of the hand-held power tool, the method comprising:
sending at least one first ID of a first protective equipment element of a first item of protective equipment to the mobile functional unit, the at least one mobile functional unit configured to control the at least one active operating state of the hand-held power tool;
receiving the at least one first ID of the first protective equipment element of the first item of protective equipment with the at least one mobile functional unit;
enabling the at least one active operating state of the hand-held power tool by with the at least one mobile functional unit by activating at least one electrical energy supply for the hand-held power tool,
wherein the mobile functional unit is integrated on or in the hand-held power tool.

2. The method as claimed in claim 1, further comprising:
sending at least one second ID of a second protective equipment element of a second item of protective equipment to the at least one mobile functional unit; and
receiving the at least one second ID of the second protective equipment element of the second item of protective equipment with the at least one mobile functional unit.

3. The method as claimed in claim 2, further comprising:
enabling the at least one active operating state of the hand-held power tool with the at least one mobile functional unit by activating the at least one electrical energy supply for the hand-held power tool upon receiving the at least one first ID of the first protective equipment element of the first item of protective equipment, and the at least one second ID of the second protective equipment element of the second item of protective equipment.

4. The method as claimed in claim 1, further comprising:
storing, in a data storage unit of the at least one mobile functional unit, a list of all IDs of the protective equipment elements of each item of protective equipment.

5. A method for enabling at least one active operating state of a hand-held power tool by at least one mobile functional unit in dependence on whether an item of protective equipment is carried and/or worn by an operator of the hand-held power tool, the method comprising:
sensing at least one first operator-specific characteristic quantity with at least one first sensor unit of a first item of protective equipment;
converting the sensed at least one first operator-specific characteristic quantity into at least one sensor signal;
transmitting the at least one sensor signal to the at least one mobile functional unit, the at least one mobile functional unit configured to control at least one active operating state of the hand-held power tool; and
enabling the at least one active operating state of the hand-held power tool with the at least one mobile functional unit by activating an electrical energy supply of the hand-held power tool,
wherein the mobile functional unit is integrated on or in the hand-held power tool.

6. The method as claimed in claim 5, wherein the at least one first operator-specific characteristic quantity is a temperature, a moisture, an acceleration and/or a capacitance.

7. The method as claimed in claim 5, wherein the at least one first sensor unit includes a temperature sensor, a moisture sensor, an acceleration sensor, a capacitive sensor or a magnetic field sensor.

8. The method as claimed in claim 5, further comprising:
storing a list of all IDs of protective equipment elements of each item of protective equipment in a data storage unit of the at least one mobile functional unit.

9. The method as claimed in claimed 5, further comprising:
sending at least one first ID of a first protective equipment element of the first item of protective equipment to at least one mobile device; and
receiving, with the at least one mobile functional unit, the at least one first ID of the first protective equipment element of the first item of protective equipment.

10. The method as claimed in claim 9, wherein the at least one first operator-specific characteristic quantity is a temperature, a moisture, an acceleration and/or a capacitance.

11. The method as claimed in claim 9, wherein the at least one first sensor unit includes a temperature sensor, a moisture sensor, an acceleration sensor, a capacitive sensor or a magnetic field sensor.

12. The method as claimed in claim 9, further comprising:
storing a list of all IDs of the protective equipment elements of each item of protective equipment in a data storage unit of the at least one mobile functional unit.

13. (canceled)

14. The method as claimed in claim 1, wherein the at least one mobile functional unit is located at an interface to a rechargeable battery of the hand-held power tool.

15. The method as claimed in claim 1, wherein the at least one mobile functional unit is located at an interface to a mains electrical power connection of the hand-held power tool.

16. The method as claimed in claim 1, wherein the at least one mobile functional unit is located in the hand-held power tool.

17. A system, comprising:
at least one mobile functional unit;
at least one hand-held power tool; and
at least one item of protective equipment having at least one protective equipment element configured to communicate with the at least one mobile functional unit,
wherein the at least one mobile functional unit is configured at least to activate an electrical power supply for the at least one hand-held power tool in dependence on whether the at least one item of protective equipment is carried and/or worn by an operator.
